(19) United States
(12) Patent Application Publication
(10) Pub. No.: US 2007/0030542 A1
(43) Pub. Date: Feb. 8, 2007

(54) Method and apparatus for compensating for atmospheric turbulence based on holographic atmospheric turbulence sampling

(76) Inventors: Robert J. Grasso, Boxford, MA (US); Leonard E. Russo, Nashua, NH (US); Robert V. McDaniel, Bedford, NH (US)

Correspondence Address: BAE SYSTEMS INFORMATION AND;ELECTRONIC SYSTEMS INTEGRATION INC., 65 SPIT BROOK ROAD, P.O. BOX 868 NHQ1-719, NASHUA, NH, 03061-0868, US

(21) Appl. No.: 11/490,596

(22) Filed: Jul. 21, 2006

Related U.S. Application Data
(60) Provisional application No. 60/705,137, filed on Aug. 3, 2005.

(51) Int. Cl. G03H 1/08

(52) U.S. Cl. 359/9

(57) ABSTRACT

A method is presented utilizing a holographic approach for linear phase conjugation to compensate for atmosphere-induce aberrations that severely limit laser performance. In an effort to improve beam quality, fine aim point control, and laser energy delivered to the target, aberration compensation is accomplished using holographic adaptive tracking that utilizes a spatial light modulator as a dynamic wavefront-reversing element to undo aberrations induced by the atmosphere, platform motion, or both. This aberration compensation technique results in a high fidelity, near-diffraction limited laser beam delivered to the target.

### RELATED APPLICATIONS

This Application claims rights under 35 USC § 119(e) from U.S. Application Ser. No. 60/705,137 filed Aug. 3, 2005, the contents of which are incorporated herein by reference.

### FIELD OF THE INVENTION

This invention relates to linear phase conjugation atmospheric turbulence compensation and more particularly to real-time holographic interactive media sampling to generate a holographic phase conjugate used to reconfigure the wavefront of an outgoing laser beam to cancel out the effects of atmospheric turbulence.

### BACKGROUND OF THE INVENTION

Atmosphere-induced aberrations can seriously degrade laser performance, greatly affecting the beam that finally reaches a target. This is especially true for propagation close to the ground and over long distances. Lasers propagated over any distance in the atmosphere suffer from a significant decrease in fluence at the target due to atmospheric aberrations. This is primarily due to fluctuations in the atmosphere over the propagation path and, to some extent, to platform motion relative to the intended aim point.

With atmosphere-induced aberrations, the effect on the beam width of a laser beam can be severe such that the fluence on the target is spread over a wide area. Uncorrected beams can have as much as a 1200 microradian divergence. This in essence spreads out the energy over the target, resulting in a decrease in effectual energy at the target with a decreased fluence at the target. In target designators, having a large area of the target illuminated may result in both non-lethal hits (enlarged circular error probability (CEP)) or not enough reflected energy to track on.

Note, most laser-based targeting systems require the delivery of high fluence to the target with a low divergence beam. However, atmospheric turbulence or platform motion results in a lack of fine aim point control to effectively keep a beam directed to a target. It will be appreciated that it is important to illuminate the target with a sufficiently narrow illumination area so that returns from the target, be they specular or diffuse, will be of sufficient intensity to be able to provide for either laser range finding or the tracking of laser energy from the target, in general for IRCM, EOCM, LIDAR and laser radar applications.

For most operational purposes, laser systems acquire targets that have diffuse surfaces and correct for the atmosphere between the platform and the target of interest so as to provide a narrow beam focused onto the target.

In the past, typical systems for correcting the outgoing engagement laser beam for atmospheric perturbations include deformable mirrors, bi-morph mirrors, bifurcated mirrors and so-called devi-rubber mirrors to be able to pre-process the outgoing laser beam to account for the atmospheric aberrations that the laser beam will experience along its path to the target.

Note that turbulence of the atmosphere manifests itself as a time-varying change in the intensity of the target that corrupts the beam as it propagates through the atmosphere.

The aforementioned deformable mirror or rubber mirror systems unfortunately can suffer from issues such as high system cost, high system complexity and the fact that one needs a lateral shearing interferometer.

Most importantly, in order for these systems to work there must be a so-called cooperative return. What this means is that the target must carry a retro-reflector so that returns from the retro-reflector can be compared with a reference beam to create a fringe pattern that represents the turbulence or the state of the atmosphere between the platform and the target.

Such cooperative targets are usually used to correct commercial point-to-point optical communications systems in which communication is to be established at some distance from the laser to a fixed point, for instance on a building structure. The building structure is provided with a retro-reflective element and a probe beam is utilized to interrogate the atmosphere between the laser and the retro-reflector. The retro-reflector operates to provide a glint, which allows one to probe the atmosphere and correct the outgoing laser beam so that as it moves in the far field the anomalies are canceled out.

Another method of ascertaining the atmospheric turbulence is to utilize a beacon, a so-called “guide star.” Basically what one uses is a laser to excite sodium-D transitions in the atmosphere and then use these transitions for laser beam correction.

Using true sodium-D lines, however, can be a challenge because one needs a specific laser wavelength to excite the specific transition and one then needs to correct the outgoing laser beam not only based on the specific transition sensed but also on offset between the transition and the actual laser wavelength.

Note that the excitation of the sodium-D lines in the upper atmosphere constitutes using a cooperative target.

Thus in the past one needed a cooperative target and either a target glint, meaning a retro-reflective target, or some means to excite a specific transition in the atmosphere.

However, if one is in a tactical or a strategic military application, one does not want to base the correction for the atmospheric turbulence upon a cooperative return because one might not in fact have a cooperative return. One would also not like to try to excite the sodium-D lines because the sodium-D lines are in the visible part of the electromagnetic spectrum, which gives away the laser's position.

The problem that one is solving is how to eliminate the atmospheric turbulence as a factor in (a) the tracking of a target in real time, (b) the correcting for the atmosphere over long distances, (c) the ability to work with a non-cooperative target, and (d) the dealing with diffuse returns as opposed to specular returns.

As will be appreciated, it is important to have a system that can work with diffuse returns that are several orders of magnitude below that associated with specular returns.

Note that when a target is illuminated, one typically gets back nearly the same amount of energy as one propagates out. If the return is off a glint, one sees a very bright spot that contains a lot of energy. If the target is diffuse, the return reflections follow the pi-squared law because of the Lambertian surface on which the laser beam falls. In short, diffuse returns are down by several orders of magnitude compared to classic adaptive optic schemes utilizing retro-reflectors and glints.

### SUMMARY OF INVENTION

Rather than utilizing cooperative targets and a lateral shearing interferometers with the requirement of a retro-reflector or excitation of the sodium-D line, in the subject invention a probing laser that is transmitted out through the engagement laser's optics illuminates the target, be it a diffuse or non-diffuse target, and the return radiation is combined with a local oscillator to provide a hologram on the focal plane array of a CCD camera.

The output of the CCD camera is an electronic hologram that is processed by an algorithm that generates the phase conjugate of the hologram and configures the surface of a spatial light modulator with the phase conjugate.

When the engagement laser illuminates the surface of the spatial light modulator that has captured the phase conjugate, its wavefronts take on the phase conjugate of the original hologram in a wavefront reversing process. When this beam is propagated out through the engagement laser's optical system into the far field, the alterations of its wavefront cancel out the atmosphere-induced phase changes, with the result that the beam that impinges on the target approximates a diffraction-limited beam.

In short, the subject system consists of two discrete steps. In the acquisition step, a low-power probe laser transmits a beam to the target. Ideally, the divergence of this acquisition beam is matched to the divergence of the engagement laser and to the target direction. A return is received and this return is collected and interfered with a reference beam from a local oscillator onto an integrating focal plane array detector such as found in a CCD camera. This forms an electronic hologram. The electronic hologram is read from the integrating focal plane array and is processed to provide the phase conjugate of the hologram, which is written to the spatial light modulator.

In the second step, which is a correction step, a beam from the engagement laser is reflected off of the surface of the spatial light modulator. The spatial light modulator acts as a phase modulator and the reflected energy is formed into a beam that has wavefronts that are the phase conjugate of the electronic hologram. When this beam retraces the path to the target, any wavefront distortions are undone, thus resulting in a near diffraction-limited beam delivered to the target.

By continually repeating the acquisition and engagement steps, moving targets can be tracked and compensation performed for time-varying aberrations in the atmosphere.

The reason that a holographic correction system is used is because a hologram contains two types of information: phase and intensity. The phase information carries the information that essentially creates the state of the atmosphere between the platform and the target in phase space. By instantiating the phase information in an electronic hologram, and by using a classic holographic interferometric technique, one can extract the phase component and process it in a very simple processor to obtain the phase conjugate.

By definition, the phase conjugate is the time reversal state of the atmosphere at an instant in time where the atmosphere is frozen. If one propagates back a wave that has the conjugate's waveform, it will go back through the aberrations and will be unaberrated in the far field.

The result is to be able to correct for atmospheric turbulence in near-real time, with the holographic technique having the benefit of simplicity. One does not need a lateral shearing interferometer, which is a relatively complex device; and does not need complex interferometric techniques.

In order for the subject system to work better with non-cooperative dispersive targets, a bootstrapping method is employed to build up signals from the noise level to usable signals. In bootstrapping, one reverses the effects of atmospheric turbulence in a multi-step process. First one reflects a first pulse from the probe beam off of the spatial light modulator and propagates it out towards the target. One then generates a first hologram from the target returns characterized by small intensity areas on the hologram at the focal plane of the CCD camera. In this first pass one is able to obtain information about the atmosphere between the laser and the target. This information is used to generate a phase conjugate that configures the face of the spatial light modulator.

When the spatial light modulator is then utilized to reflect a second pulse, the second probe pulse will be propagated out and arrive at the target with a more narrowed beam based upon the information from the originally generated hologram. This second pulse retraces the path to the target and comes back, whereupon a second hologram is produced. The second hologram is then utilized to form a second phase conjugate on the spatial light modulator. The process with the probe laser is repeated in which successive probe pulses produce successive holograms and successive phase conjugates.

Thereafter, the engagement laser projects a pulse towards the spatial light modulator. Because the last of the successive phase conjugates reflects a much-enhanced signal-to-noise ratio, the wavefronts of the engagement laser pulses are robustly compensated.

This iterative bootstrapping process converges to a solution in, for instance, as little as three pulses, building up the atmospheric turbulence signal from the noise. This means that one can work with very noisy holograms and by bootstrapping permit diffuse, far-off targets to be illuminated with near diffraction-limited engagement laser beams.

In summary, a method is presented utilizing a holographic approach for linear phase conjugation to compensate for atmosphere-induced aberrations that severely limit laser performance. In an effort to improve beam quality, fine aim point control, and laser energy delivered to the target, aberration compensation is accomplished using holographic adaptive tracking that utilizes a spatial light modulator as a dynamic wavefront-reversing element to undo aberrations induced by the atmosphere, platform motion, or both. This aberration compensation technique results in a high fidelity, near-diffraction limited laser beam delivered to the target.

### BRIEF DESCRIPTION OF THE DRAWINGS

These and other features of the subject invention will be better understood in connection with the Detailed Description, in conjunction with the Drawings, of which:

FIG. 1 is a series of diagrammatic illustrations showing the effect of atmospheric turbulence on a transmitted laser beam in which the beam is uncorrected, in which the beam is wander-corrected, and in which the beam is corrected using the subject holographic wavefront measurement system coupled to a spatial light modulator;

FIG. 2 is a graph showing beam diameter versus distance for an uncorrected beam, for a wander-corrected beam, and for a beam corrected using the subject holographic technique;

FIG. 3 is a block diagram of the subject atmospheric aberration correction system illustrating the use of a probe laser, a local oscillator, a focal plane array camera on which an electronic hologram is generated, and a processor for the calculation of the hologram phase conjugate that is imparted to the surface of a spatial light modulator which, when illuminated with an engagement laser beam, alters or wavefront-reverses the impinging beam such that when it traverses the path to the target, the aberrations of the beam caused by atmospheric turbulence are canceled to minimize beam diameter such that the fluence on the target is maximized;

FIGS. 4A, 4B and 4C are graphs showing the effect of bootstrapping to be able to correct an engagement laser output based on returns from diffuse objects, showing the intensity of electronic hologram pixels at the focal plane array camera of FIG. 3 for a first probe pulse to provide a somewhat narrowed beam, the results of which are utilized to reconfigure the spatial light modulator to reflect a second probe pulse, with the returns from the second probe pulse providing an electronic hologram in which pixels associated with atmospheric aberrations are amplified over the noise, with the conjugate of the second hologram used to alter the engagement laser beam when the engagement laser beam is reflected by the spatial light modulator; and,

FIG. 5 is a flow chart representing the Gershberg-Saxton algorithm for converting the electronic hologram on the CCD camera to its phase conjugate.

### DETAILED DESCRIPTION

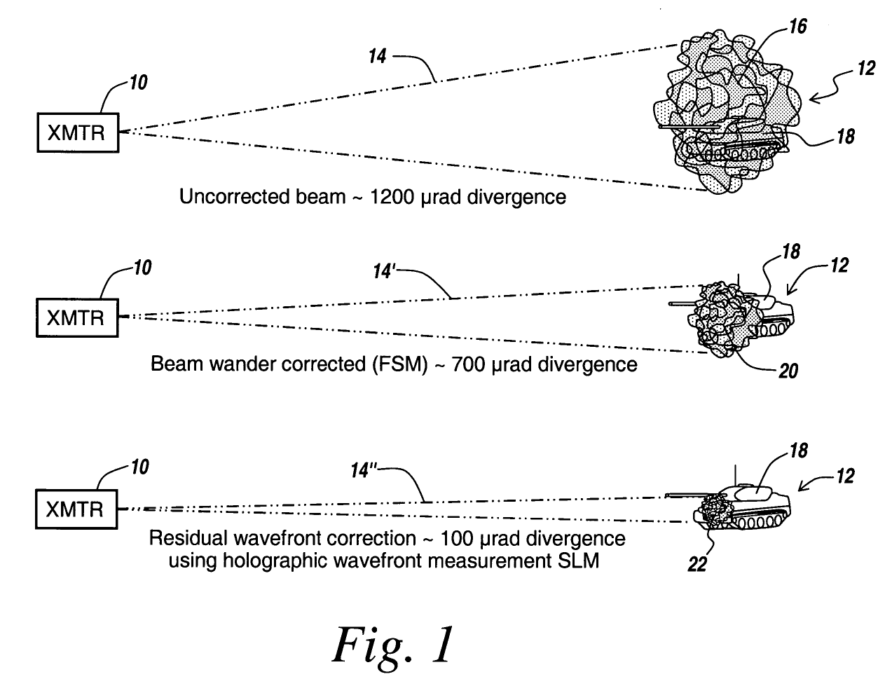

Referring now to FIG. 1, there are a series of diagrams involving the beam spread of a laser beam, which beam spread is due to atmospheric turbulence between a transmitter 10 and a target area 12.

For an uncorrected laser beam there can be as much as a 1200 microradian divergence of beam 14 such that at the target area the area subtended by the beam, here illustrated at 16, is relatively large and can, for instance, be much larger than the target that is intended to be illuminated.

If beam 14 is wander-corrected as illustrated by beam 14′, meaning corrected by SFM techniques, then one could expect an approximate 700-microradian divergence, which would paint a target 18 with a relatively wide illumination pattern 20 that in this case completely obscures the target. More importantly, it is impossible with the wander-corrected beam to be able to pinpoint a part on a target for which a kill would be maximally effective.

As can be seen from beam 14″, the residual wavefront correction results in an approximate 100 microradian divergence utilizing the subject holographic wavefront measurement and spatial light modulator system.

Here it can be seen that the portion of target 18 illuminated is indeed quite small in area as illustrated at 22, meaning that the diameter of the beam impinging on the target has been reduced as much as possible. This is because the beam 14″ is a near diffraction-limited beam.

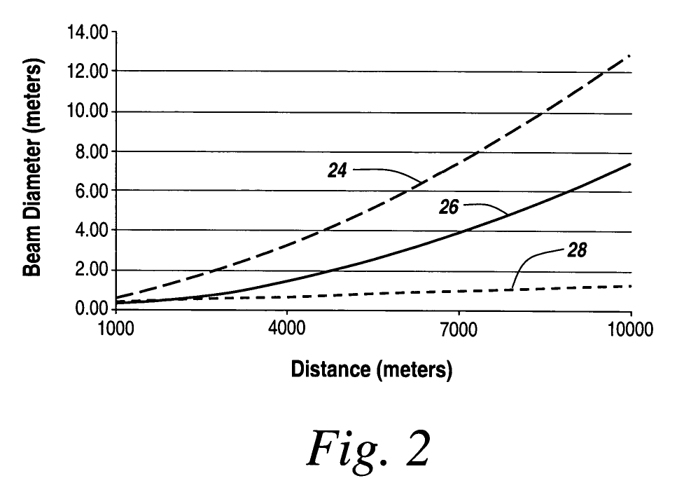

As can be seen from FIG. 2, beam diameter increases with distance, especially in the uncorrected case as illustrated by dotted line 24. The wander-corrected beam diameter is illustrated by solid line 26, whereas the near diffraction-limited beam diameter with the atmospheric aberrations canceled is illustrated by dotted line 28.

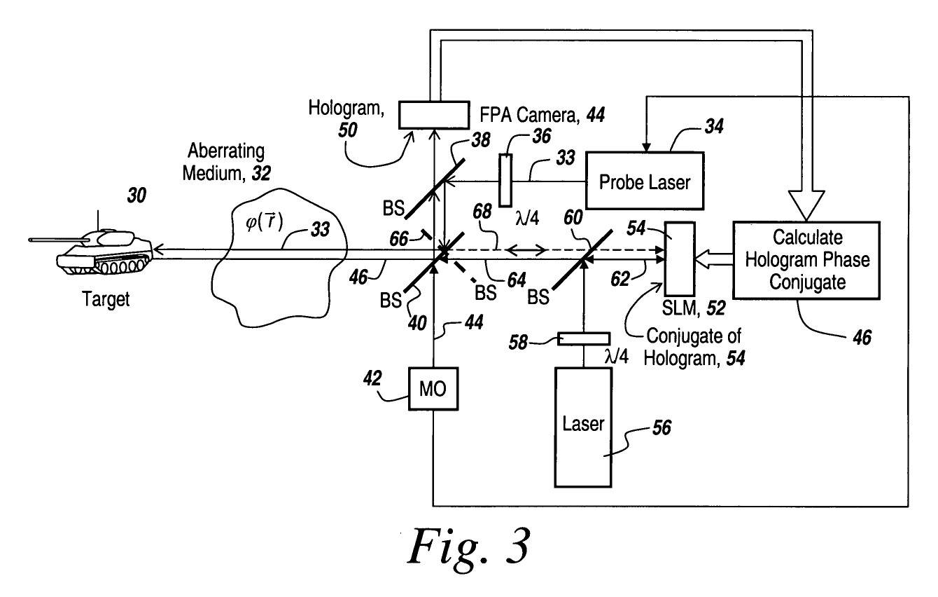

As mentioned hereinbefore and referring now to FIG. 3, the subject technique utilizes a holographic approach to linear phase conjugation to compensate for atmosphere-induced aberrations that severely limit laser performance. The subject technique also improves beam quality, provides fine aim point control, and maximizes the energy delivered to the target.

As mentioned above, the subject system uses a spatial light modulator as a dynamic wavefront-reversing element to undo aberrations induced by the atmosphere, platform motion or both. The result is a high-fidelity, near diffraction-limited laser beam delivered to the target.

In order to project a diffraction-limited beam uncorrupted by atmospheric turbulence to a target 30, in a first step to probe the medium between the laser and a target 32, the beam 33 from a probe laser 34 is projected through a quarter wave plate 36 onto a beam splitter 38, which redirects the probe laser beam downwardly towards a second beam splitter 40 that redirects probe laser beam 33 along the optical axis of the system. Returns from target 30 are redirected by beam splitter 40 up through beam splitter 38 to impinge on the focal plane array of an FPA camera 44.

An electronic hologram is set up on the focal plane array of camera 44 by interfering with the returns from the target with the output of a master oscillator 42, which projects a beam 44 that interferes with the returned beam 46 such that a hologram 50 is formed on the focal plane array of camera 44. The camera therefore produces what is known as an electronic hologram, which is coupled to a processor 46. Processor 46 calculates the hologram phase conjugate for each of the pixels in the camera and provides these values, pixel by pixel, to spatial light modulator 52. Spatial light modulator 52 has a surface 54 that is reflective and through the driving of the elements of the spatial light modulator provides a reflective surface that carries the phase conjugate of hologram 50, namely conjugate 54.

The reflective surface of the spatial light modulator carrying the phase conjugate produces a wavefront reversal for the beam from an engagement laser 56 when this beam is reflected by the spatial light modulator. The beam from the engagement laser passes through a quarter wave plate 58 and is redirected by a beam splitter 60 along path 62 onto the face 54 of the spatial light modulator. Here the wavefront of the pulses from laser 56 is altered or reconfigured so that when reflected back along path 62 they pass through beam splitter 60 out along path 64 and out through beam splitter 40 towards target 30.

It is the purpose of the subject system to provide a pattern on the spatial light modulator such that when a laser beam impinges on its surface, its wavefront is reversed in accordance with the phase conjugate of the electronic hologram formed by the probe laser. When this phase-reversed wavefront propagates through the aberrating medium, namely medium 32, the aberrating effects are canceled, thereby to restore the original diffraction-limited beam width to the engagement laser 56.

As can be seen in FIG. 3, the master oscillator or local oscillator can be used to seed either the probe laser or the engagement laser. This is useful when both the probe laser and the engagement laser operate at the same wavelength.

However, if the probe laser is to operate a different wavelength from the engagement laser, then the holograms and the phase conjugates must be corrected for the difference in wavelength.

The above system addresses atmospheric issues, namely the laser propagation being affected by absorption, scattering, turbulence, beam wander, spread, breakup, scintillation and refractive index changes.

Both natural and artificial atmospheric turbulence, as mentioned before, impact laser propagation. Turbulence is random with spatial and temporal statistics. This means that the beam passes through different portions of space every time the wind moves it one diameter. This, in turn, affects coherence length and the maximum diameter of a collector allowed before atmospheric distortion limits performance.

It is also noted that the subject hologram also contains target angular position, in terms of phase and intensity and time of flight range. This angular information can be used to construct a track file such that the direction to the target can be derived from the intensity pattern of the hologram. Also there is a one-to-one correspondence between the position on the array and the target direction. Thus the subject system can automatically track the target while providing pointing and aberration compensation.

In short, the atmosphere is sampled by the probe beam, which is propagated towards the target. The hologram is written on the camera by interfering the return signal with the master oscillator or local oscillator. Aberration compensation is accomplished because the hologram is transferred to the spatial light modulator in terms of its conjugate, with a one-to-one pixel registration between the focal plane array of the camera and the spatial light modulator being maintained. As a result, laser beams reflected off the spatial light modulator come off with a corrected wavefront and are propagated towards the target.

It is noted that in the subject system, wavefront distortions between the laser and the target are undone by the projecting of a wavefront-corrected beam towards the target, resulting in a near diffraction-limited beam, which is delivered to the target. This means that moving targets can be tracked by continually repeating acquisition and correction.

More particularly, in the subject invention, what is done is combining the return beam from the probe with a local oscillator to generate the hologram that is then focused on the CCD array or camera.

The processing that takes place from the camera to the spatial light modulator, which is the wavefront-reversing element, involves a very simple computer architecture.

Thus the conjugate derived from the output of the camera is applied to the spatial light modulator. It will be appreciated that the spatial light modulator replaces the deformable mirrors in the classic adaptive optical architectures.

By having a one-to-one pixel correspondence between the camera and the spatial light modulator, one can have a very high fidelity corrected waveform, up to the fill factor of the spatial light modulator, which in many cases can exceed 85%. Thus the conjugate fidelity can be very, very high.

The conjugate processing and driving of the spatial light modulator can be performed very quickly because spatial light modulators operate at many kilohertz. Since the atmospheric decorrelation time is on the order of a millisecond, the subject devices can correct many times faster than the atmospheric decorrelation time, making the subject technique unlimited by available hardware.

From the point of view of the camera, its output is coupled to a conjugate processor where values at each pixel in the hologram are processed to extract the phase and intensity information. Once one has the phase information, one can create a conjugate of the phase information.

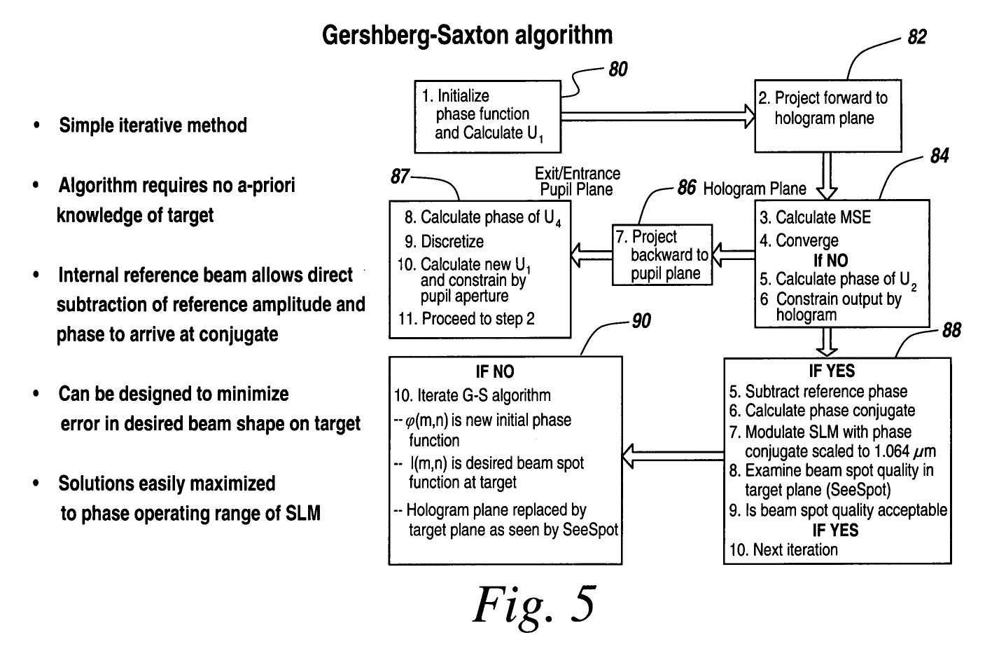

As shown in FIG. 5, one conjugate processing algorithm that is relatively simple and straightforward is the Gershberg-Saxton Algorithm, which is a simple, very robust algorithm that can perform the process by simply iterating over multiple points and converging to the conjugate solution in a very short amount of time. While there are other algorithms that could be used, the phase conjugation process itself is very simple and straightforward.

The outputs of the algorithm are utilized to drive the spatial light modulator pixels, with the conjugate processor providing a number of values that drive the spatial light modulator pixel by pixel.

Note that the spatial light modulator can be driven at different rates depending on the fidelity of the correction. What has been found is that in atmospheric turbulence, one would need anywhere from a single bit of correction to a maximum of three bits of correction. A single bit of correction means that each pixel would have a throw equal to the amount it would take to compensate for that atmospheric cell.

A three-bit architecture would mean that one would have eight levels of gray scale. Note that a single-bit architecture is either on or off, meaning that the pixel is displaced or not. In a three-bit architecture, one has eight levels of displacement within the pixel.

It has been found that atmospheric correction only requires single-bit compensation. This translates into single-bit level correction.

The spatial light modulator is a simple device that consists of pixels. It is an analog to a focal plane array that works by displacing an element, and displacing can be either a piston motion, which is for phase, or it can be the rocking of a pixel back and forth, which is for amplitude.

In the subject invention, one uses the phase because one is generating the phase conjugate of the hologram.

Note that when utilizing the piston-type reflective surface device, one alters the phase of the light that is coming in, meaning the wavefront of the light that impinges upon the surface of the spatial light modulator and gets reflected is altered. In one embodiment of the subject invention, in terms of the actual movement of the pixels, they are moved by micrometers.

Thus, when one looks at the face of the spatial light modulator after it has been driven by the conjugate, one gets the phase conjugate of the original hologram. In short, what one is doing is generating the conjugate of the hologram on the face of the spatial light modulator.

In addition to the atmospheric turbulence for which correction is desired, there is of course the problem of the motion of the laser platform itself. When, for instance, the platform is carried on an aircraft and is moving through the atmosphere at relatively high speeds, there can be perturbations in the position of the platform that occur at a periodic rate in the tens to possibly several hundreds of kilohertz. Note that these perturbations are again slow enough for the system to compensate.

As will be appreciated, fast-moving aircraft can provide very turbulent wakes at the boundary layer and in some cases have to be compensated for in a much faster time interval than would be the case for atmospheric turbulence. This may require response times characterized by hundreds of kilohertz, which would require correcting as fast as tens of microseconds. One would therefore need a spatial light modulator that has a high update rate or a fast frequency response. Note that the spatial light modulator must operate in a time interval either as short or shorter than the decorrelation time in order for the subject system to work.

If one is working from a very fast-moving platform, one needs to be able to compensate faster than the platform is disrupting the atmosphere and creating turbulence. As mentioned above, this could be on the order of tens to hundreds of kilohertz.

Fortunately, most spatial light modulators can work in this region. Specifically, the Boston Micromachines spatial light modulators can operate up to several hundreds of kilohertz, even up to a megahertz. This allows for compensation for even the most severe turbulence generated by a platform moving through the atmosphere.

Note that for the classic adaptive optic-type architectures, these are typically limited by the time it takes to deform a deformable mirror, which is on the order of a few kilohertz. However, with situations demanding 100 KHz operation or better, these classic systems fail.

The reason that the subject technique benefits from the holography is that it allows one to use a local oscillator as a reference for the entire system, whereas in the classic adaptive optic approach one does not have a reference for the entire system. In the classic interferometer, one uses a reference but one only gets that after one interferes the two beams. However, in the subject approach, the lasers are locked up to a single reference source.

As will be appreciated, the maximum energy on target efficiency factor for the engagement laser is roughly equal to the number of spatial light modulator pixels multiplied by the hologram efficiency. Note that the greater the number of pixels, the greater the performance that can be realized.

Note also that the subject technique provides automatic target acquisition within its field of view as well as atmospheric aberration compensation. When compared to conventional adaptive optical schemes, no wavefront reconstruction algorithms are required. Additionally, when compared to all optical phase conjugation schemes that require very high optical amplification factors up to 10¹⁵, amplification of the target return is not required in the subject system.

As will be appreciated, the spatial light modulator behaves as a dynamic wavefront-reversing element to undo aberrations induced by the atmosphere, platform motion or both. The hologram formed on the camera is transferred in conjugate form pixel by pixel to the spatial light modulator, with the conjugate of the hologram formed on the camera containing both intensity and phase information about the intervening medium between the spatial light modulator and the target.

Note that the subject system is a homodyne process that exhibits the high gain of a coherent detection process without the field of view limitation characteristic of a heterodyne process.

### Bootstrapping

While the system thus described enables significant beam limiting through the phase conjugate cancellation process, the system can be improved by a so-called bootstrapping process in which the measurement of the atmospheric aberrations is amplified over the noise level.

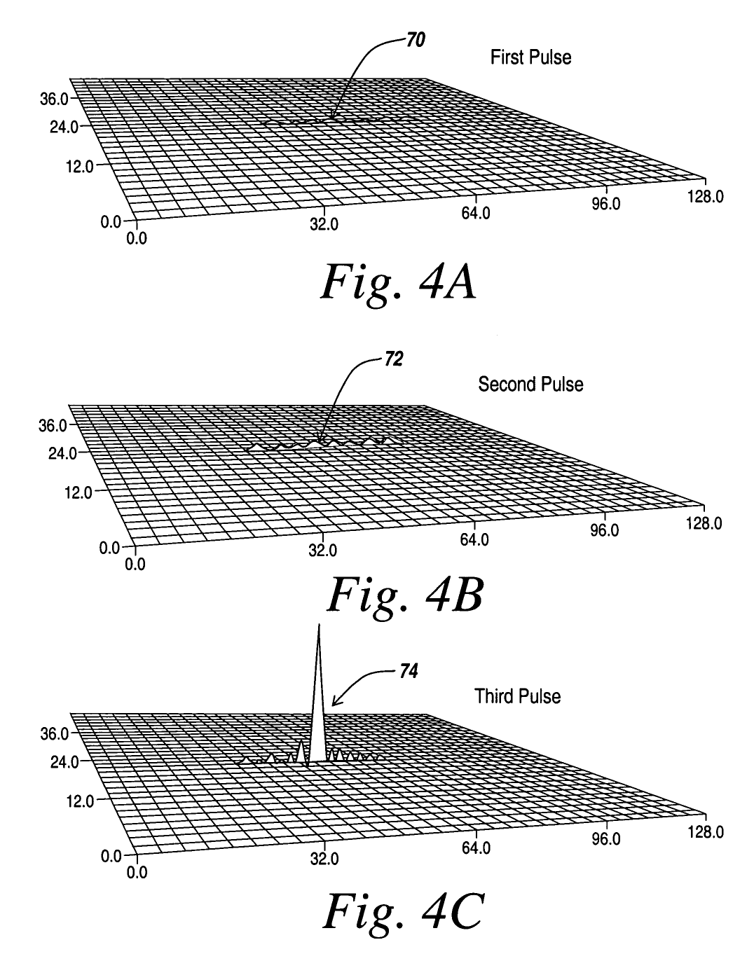

Referring to FIG. 4A, what is shown is a grid on the focal plane array of the camera. The intensity of the hologram created on the face of the focal plane array when using a probe laser can result in intensities 70, which are barely perceptible above the noise level due, for instance, to returns from a diffuse surface that is far away from the probe laser. It is noted that the intensity of the hologram is proportional to the output of the probe laser, which in most cases is limited to milliwatts.

In order to enable the subject system to work at great distances and with diffuse targets, the intensities of the hologram on the surface of the focal plane array can be amplified or magnified through a bootstrapping system involving multiple probe laser pulses.

Assuming that the probe laser emits a first pulse, then as can be seen from FIG. 3, the first pulse is directed along path 33 to the target and is reflected along path 33 back through beam splitter 38, where it impinges upon the focal plane array of camera 44.

Hologram 50, which is formed by interacting the output of the master oscillator 42 with the return from the target, produces a hologram relating to the first pulse in which the intensity of the hologram as indicated at 70 is not much above the noise level.

When the hologram associated with the first pulse is used to generate its phase conjugate supplied to spatial light modulator 52, and when the reflective surface of the spatial light modulator is illuminated with a pulse from the probe laser, then reflections from the target form a second hologram on the focal plane array of camera 44 that has an amplified or increased intensity 72 as illustrated in FIG. 4B. In order to change the wavefront of the probe laser, the beam of the probe laser is redirected by a switchable beam splitter 66 that redirects the probe beam to the spatial light modulator over path 68. Thereafter the wavefront-adjusted beam is directed to target 38.

The enhanced amplitude or intensity hologram is utilized to provide a second hologram phase conjugate that more robustly reflects the atmospheric turbulence along the path to target 30.

Having formed a second holographic phase conjugate on the reflective surface of the spatial light modulator, if one reflects a third pulse, for instance, from the probe laser, and one propagates this wavefront-reversed pulse to the target 30, then returns from the target relating to this third pulse form a hologram that is the result of this third pulse. This hologram has much-amplified intensities as illustrated at 74 in FIG. 4C. Thereafter the engagement laser may be directed to the spatial light modulator with this new phase conjugate. The result is an even better diffraction-limited beam.

Here it can be seen that the measurement of the atmospheric turbulence is in terms of an enhanced-amplitude electronic hologram that, when used to form a hologram phase conjugate on the reflective surface of the spatial light modulator, results in robust wavefront correction for the engagement laser.

This iterative bootstrapping process can take the relatively low-level returns from a diffuse target and amplify the measurement of the atmospheric turbulence such that within three or four iterations one can have an extremely robust conjugate formed on the reflective surface of the spatial light modulator, with each iteration further narrowing the beam divergence regardless of the power level of the laser used to illuminate the target and regardless of the diffuse nature of the reflections from the target.

As to the Gerschberg-Saxton (G-S) phase retrieval algorithm, this algorithm operates jointly on data from the entrance/exit pupil plane and hologram plane. This algorithm uses the hologram on the FPA as the seed for its merit function; i.e., the mean square error (MSE) which is described below. The hologram is created by the interference at the phase detection camera of the known reference optical field, R=R*exp(jφR), and the aberrated optical field scattered from the object, O=O*exp(jφO). Here, “R” and “O” are amplitudes and φ_{R} and φ_{O} are phases of the optical fields, respectively. The object wavefront, or phase function, φ_{O}, contains contributions from the target, background, and aberrations from atmospheric turbulence. The recorded hologram, I_{H}(m,n), where “m,n” are pixel coordinates, is given by:

$$\begin{matrix}{I}_{H} = {\vert R + O \vert}^{2} = ( R + O ) ( {R}^{*} + {O}^{*} ) \\ = {RR}^{*} + {OO}^{*} + {RO}^{*} + {OR}^{*} \\ = {R}^{2} + {O}^{2} + {RO}^{*} + {OR}^{*} \\ = {R}^{2} + {O}^{2} + 2 RO * cos ( {φ}_{R} - {φ}_{O} )\end{matrix}$$

$$where {(}^{*} ) denotes the complex conjugate .$$

The algorithm is iterative, employing both Fast Fourier Transform (FFT) and inverse FFT as forward and backward propagation kernels. The algorithm generates a uniform random phase function φ(m,n), with the range −π<φ<π, then creates a unitary optical field, U₁(m,n)=exp(jφ(m,n)).

U₁ is multiplied and shaped by an aperture transmission function defined at the plane of the optical system exit/entrance pupil; it is mathematically propagated forward from this pupil plane, via the FFT, to the phase detection camera (FPA) plane, the hologram plane. The resulting optical field in the hologram plane is U₂. Now, the algorithm calculates the MSE between the normalized squared magnitude of U₂ and the normalized recorded hologram, I_{H}(m,n). This MSE is the merit function.

If the MSE is less than a predetermined value, algorithm convergence is established and the algorithm exits. Otherwise, the algorithm continues as follows: 1) phase of U₂ is calculated and a new unitary optical field, U₃, is generated; 2) U₃ is multiplied by the square root of I_{H}; 3) U₃ is propagated, via inverse FFT propagation kernel (FFT¹), back to the entrance/exit pupil plane, yielding optical field U₄; 4) U₄ phase is calculated and becomes the new choice for φ(m,n), and; 5) a new U₁ is generated. This iteration continues until convergence is achieved and the MSE is less than the preset value.

Convergence signifies that the last calculated phase function represents the wavefront at the pupil plane that generates the hologram recorded at the camera plane: φ(m,n)=φ_{R}−φ_{O}. The known reference phase function, φ_{R}, is subtracted from φ(m,n) yielding the aberrated object phase function, φ_{O}. The negative of this function is scaled in space and magnitude by the factor (λ_{engagement}/λ_{probe}) representing the phase difference between the engagement and probe laser wavelengths. This new phase function is written to the SLM to correct the engagement laser. Phase calculations do not require phase unwrapping as the iteration technique optimizes the phase function to values in the range (−π, π) and constrains the output to the desired image. The process repeats on every pulse.

More particularly, referring now to FIG. 5, the Gershberg-Saxton algorithm is described in which as a first step indicated at 80 one initializes the phase function and calculates U₁. Thereafter, as illustrated at 82, one projects forward to the hologram plane. As seen at 84, at the hologram plane one calculates MSE and attempts a conversion. If conversion is not achieved, then one calculates the phase of U₂ and constrains the output by the hologram. As illustrated at 86, one projects backward to the pupil plane and as illustrated at 87 one calculates the phase of U₄, discretizes the result, calculates a new U₁ that is constrained by the pupil aperture and proceeds back to Step 2 with a new U₁ having been calculated.

As illustrated at 88, if there is a convergence at 84, then one subtracts the reference phase, calculates the reference phase conjugate, modulates the spatial light modulator with its phase conjugate, in one embodiment scaled to 1.064 μm, examines beam spot quality in the target plane, and if the beam spot quality is acceptable, goes on to the next iteration. As illustrated at 90, if the beam spot quality is not acceptable, one reiterates the Gershberg-Saxton algorithm where φ(m,n) is the new initial phase function, I(m,n) is the desired beam spot function at the target and the hologram plane is replaced by the target plane.

The above provides a simple iterative method in which the algorithm requires no a priori knowledge of the target.

Note the internal reference beam allows direct subtraction of a reference amplitude and phase to arrive at the conjugate. The Gershberg-Saxton algorithm can be designed to minimize error in the desired beam shape on the target and solutions can be easily maximized to the phase operating range of the spatial light modulator.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for correcting for atmospheric- and platform-induced aberration of a laser beam to provide a near diffraction-limited laser beam impinging on a target, comprising the steps of:
probing the target with a probe beam from a probe laser;
forming an electronic hologram from returns from the probe beam;
driving a spatial light modulator with the phase conjugate of the electronic hologram to provide a reflecting surface carrying the phase conjugate; and,
reflecting the beam from an engagement laser off the reflecting surface and out along the path of the probe beam to the target.

2. The method of claim 1, wherein the electronic hologram is formed by target returns interacting with the beam from a local reference oscillator.

3. The method of claim 2, wherein the wavelength of the probe beam and the engagement laser beam are equal.

4. The method of claim 1, wherein the wavelength of the probe beam and the engagement laser beam are different.

5. The method of claim 4, wherein the phase conjugate is adjusted in accordance with the difference between the two wavelengths.

6. The method of claim 1, wherein the phase conjugate is generated using the Gershberg-Saxton algorithm.

7. The method of claim 1, wherein the step of driving the spatial light modulator with the phase conjugate of the electronic hologram includes the step of bootstrapping to improve the signal-to-noise ratio of the electronic hologram.

8. The method of claim 7, wherein the bootstrapping step includes the steps of probing the target with a first pulse from the probe beam; generating a first electronic hologram from target returns from the first probe pulse; driving the spatial light modulator with a first phase conjugate of the first electronic hologram; reflecting a second probe pulse off the spatial light modulator to the target, generating a second electronic hologram from target returns from the second probe pulse; driving the spatial light modulator with a second phase conjugate of the second electronic hologram; and reflecting the engagement laser beam off the spatial light modulator carrying the last phase conjugate.

9. The method of claim 8, wherein multiple probe pulses are used, wherein corresponding phase conjugates drive the spatial light modulator, and wherein the beam from the engagement laser is directed towards the spatial light modulator only after a predetermined number of probe pulses and corresponding phase conjugates have driven the spatial light modulator.

10. The method of claim 2, wherein the beam from the local oscillator is used to seed the probe laser.

11. A method for compensating for atmosphere-induced aberrations between an engagement laser and a target, comprising the step of:
using a holographic approach for linear phase conjugation to dynamically reverse wavefront elements such that the reversed wavefront elements in the output of the engagement laser cancel atmosphere-induced aberration, thus to improve engagement laser beam quality, aim point control and laser energy delivered to the target.

12. In a method for illuminating targets with an engagement laser, the improvement comprising utilizing a holograph to effect a linear phase conjugation to alter the output of the engagement laser.

13. The method of claim 12, wherein the holograph is generated from a laser return from the target interacted with a local oscillator.

14. The method of claim 13, wherein the altering of the output of the engagement laser includes altering the wavefronts thereof.

15. The method of claim 14, wherein the wavefronts are altered in accordance with the phase conjugate of the holograph.
